(19) United States
(12) Patent Application Publication
(10) Pub. No.: US 2026/0008305 A1
(43) Pub. Date: Jan. 8, 2026

(54) SYSTEM AND METHOD FOR CHANGING LOAD DISTRIBUTION ON WHEELS OF A VEHICLE WHEN HITCHED TO A TRAILER

(71) Applicant: Red Automotive Technologies Pty Ltd, Brompton (AU)

(72) Inventors: Paul Van De Loo, Norton Summit (AU); Ryan Schulz, Prospect (AU)

(73) Assignee: Red Automotive Technologies Pty Ltd, Brompton (AU)

(21) Appl. No.: 19/136,236

(22) PCT Filed: Dec. 8, 2023
(86) PCT No.: PCT/AU2023/051278

§ 371 Date: Jun. 5, 2025

(30) Foreign Application Priority Data
Dec. 9, 2022 (AU) 2022903772

(51) Int. Cl. B60D 1/24; B60D 1/167; B60D 1/62

(52) U.S. Cl. CPC B60D 1/247; B60D 1/167; B60D 1/62

(57) ABSTRACT

Systems 40 are described for changing the load applied to wheels 18 on different axles A1, A2 of a towing vehicle 10 to minimise the adverse effect on the dynamics and operation of the vehicle 10 created by the pitch moment applied by a hitched trailer 12. The systems 40 include a force generator 42 arranged to apply a force between the vehicle 10 and the trailer 12, and a force transmission coupling 44 arranged to transmit force applied by the force generator 42 for the purpose of changing the load applied to the wheels 18 by the trailer 12. This change is to counter or oppose the change in load produced by hitching of the trailer to the vehicle. The systems 40 are applicable to various types of hitching arrangements including a ball joint type hitch and a four-bar articulated joint.

### TECHNICAL FIELD OF THE INVENTION

The present invention relates to a system and method for changing the load distribution on the wheels of a vehicle when hitched to a trailer.

### BACKGROUND OF THE INVENTION

Trailers are commonly towed by vehicles on and off road. Typical on-road applications for trailers include caravans, horse floats and general goods carrying trailers towed behind passenger vehicles. Trailers are also often towed behind trucks, greatly increasing their load transportation ability. The vehicle and trailer are connected using a tow hitch.

Before continuing with a background description, and to ensure consistency in the language used throughout this specification, it should be understood that terms designating direction, such as forward and aft, will be used throughout this specification in the context of a vehicle-trailer combination on a roadway travelling in a normal direction, that is with the vehicle forward of the trailer.

Other terms such as roll, pitch and yaw are used throughout this specification in the conventional context commonly used for vehicles, with the roll axis being aligned with the direction of straight-ahead travel or the longitudinal axis of the vehicle, the pitch axis being the axis perpendicular to this in the horizontal plane, and the yaw axis being mutually orthogonal to these, namely being the turning axis or vertical axis. In general, there are six independent degrees of freedom in which an object can move, being three in translation along the mutually orthogonal pitch, roll and yaw axes, and three in rotation about the pitch, roll and yaw axes.

The present invention relates to apparatus for changing the load distribution on the wheels of a towing vehicle. There are also other terms commonly used instead of “load distribution” such as “weight distribution” and “load levelling”. These terms are used interchangeably in this specification.

A tow hitch securely attaches a trailer to the rear of a vehicle whilst allowing freedom of roll, pitch and yaw movement between them. For on-road use the angle of rotation required about each axis can be small, however for off-road use larger angles are required to cope with more uneven terrain. It is also desirable to have full 360-degree rotation in roll to prevent the trailer from overturning the vehicle in the unfortunate instance of a trailer rollover.

Tow hitches used on passenger vehicles and the like typically consist of a ball joint comprising a tow ball on a tow bar on the rear of the vehicle and a female receiver on the trailer. Other tow hitches separate the rotation axes into separate pivots, but the centre of rotation of each rotation axis is typically located at or near the same point, and at basically the same location, as a ball joint type hitch. Having the centre of pitch rotation of a trailer at the position of a tow ball, which is rearwards of the rear axle of the vehicle (often referred to as an “overhung” hitch), can be undesirable for the distribution of trailer weight onto the vehicle.

Overhung hitches tend to be the only option for wagon and sedan type vehicles where it is not possible to have a hitch above the rear axle, such as a fifth-wheel arrangement that can be used with pick-up trucks and the like. With overhung hitches, the hitch is thus usually situated on a vehicle tow bar mounted to the rear face of the vehicle. The tow ball for such an arrangement is then typically mounted just aft of the rear face of the vehicle, the rear face being defined as a vertical plane coincident with the rearmost extremity of the vehicle body work or chassis, such as (typically) the rear bumper bar.

Typically, some of the weight of the trailer is carried by the vehicle via the tow hitch. It is common for 5% to 10% of the weight of the trailer to be carried by the tow hitch, resulting in a downwards force on the tow hitch equal to around 5-10% of the weight of the trailer. This is termed the drawbar weight. When the hitch is overhung, this downwards force produces a moment on the vehicle about its rear axle which has the effect of reducing the weight carried by the front wheels and increasing the weight carried by the rear wheels. The total increase in weight carried by the rear wheels when the trailer is hitched is more than the drawbar weight. The greater the length of overhang, the more pronounced this amplification is. This weight transfer from the front wheels to the rear will tend to change the pitch inclination of the vehicle on its suspension and can adversely affect the handling qualities of the vehicle.

It should be noted, and as will be obvious to one skilled in the art, that any location where the drawbar weight is applied to the vehicle that is aft of the centre of gravity (CG) of the vehicle, the drawbar weight will increase the weight on the rear wheels proportionally more than the increase on the front wheels. As this location is moved aft of the CG this effect becomes more pronounced, until at the point where the location is coincident with the rear axle all of the drawbar weight is applied at the rear wheels and none at the front. As the location is moved still further aft into the “overhung” region the front wheels are unloaded and the rear wheel loading is increased by more than the drawbar weight.

Mechanical systems for load levelling are presently available which use spring bars. While the systems are effective they are cumbersome, require the use of several different components and can take considerable time to install requiring weight and height measurements, and use of charts for selection of appropriate spring bars. One example of a such a load levelling system involves:
inserting a drop shank into a hitch receiver of a towing vehicle;
sliding a ball mount head up the drop shank;
attaching a tow ball to the ball mount head;
attaching snap up brackets to the trailer A frame
coupling the tow ball with a receiver on the trailer;
connecting one end of a pair spring bars to the ball mount head;
connecting the other end of the spring bars using chains to hawks on the snap up brackets; and
using a lever to lift the brackets into place.

Embodiments of the present invention attempt to provide an improved apparatus for distributing the drawbar weight of a trailer on a tow hitch on a vehicle between the front and rear axles of the vehicle, particularly, but not limited to, overhung tow hitches.

Before turning to a summary of the present invention, it must be appreciated that any description of prior art is provided merely as background to explain the context of the invention. It is not to be taken as an admission that any of the material referred to was published or known or was a part of the common general knowledge in Australia or elsewhere.

### SUMMARY OF INVENTION

In one aspect there is disclosed a system for enabling a change in load applied to wheels on different axles of a vehicle about a pitch axis of the vehicle by a trailer when coupled to the vehicle by a hitch coupling, the system comprising:

a fluid or electrically operated force generator arranged to apply a force between the vehicle and the trailer, and a force transmission coupling arranged to transmit the force applied by the force generator to the vehicle to change the load applied to the wheels by the trailer about the pitch axis.

In one embodiment the trailer is coupled to the vehicle at an overhung hitch location.

In one embodiment the force is applied as a moment about the pitch axis in a direction opposite to a moment produced by a coupled trailer about the pitch axis when coupled to the vehicle.

In one embodiment the system comprises a forward articulated joint coupled between the vehicle and the force generator, wherein the forward articulated joint provides at least one degree of freedom of rotational motion.

In one embodiment the at least one degree of freedom of rotational motion is rotational motion about a yaw axis of the vehicle.

In one embodiment the system comprises a rearward articulated joint coupled between the force generator and the trailer, wherein the rearward articulated joint provides at least one degree of freedom of rotational motion.

In one embodiment the force transmission coupling is arranged to transmit the mechanical force as a moment in a direction about the pitch axis that acts to reduce the load applied to the wheels by the trailer.

In one embodiment the system comprises a driver arranged to drive or operate the force generator for producing the mechanical force.

In one embodiment the system comprises a jockey wheel extension and retraction mechanism operative associated with the driver.

In one embodiment the force generator includes a fluid driven generator.

In one embodiment the fluid driven generator is a hydraulic cylinder or a pneumatic cylinder, or a hydropneumatic cylinder.

In one embodiment the fluid driven generator is a hydraulic cylinder and the system further comprises a pump for supply fluid pressure to the hydraulic cylinder.

In one embodiment the system comprises an accumulator in fluid communication with the fluid driven generator and the pump.

In one embodiment the force generator includes a manual, electrical, or fluid driven jack.

In one embodiment a spring is mounted in series with the jack to provide substantially constant force over a range of motion of the jack.

In a second aspect there is provided a method of enabling a change in load applied to wheels on different axles of a vehicle about a pitch axis of the vehicle by a trailer that when coupled to the vehicle by a hitch coupling, the method comprising:
applying a force between the vehicle and the trailer, and
transmitting the force to the vehicle at a location rearward of the vehicle axles to change the load applied to the wheels by the trailer about the pitch axis.

In one embodiment transmitting the force comprises transmitting the force as a moment about the pitch axis in a direction opposite to a moment produced by the trailer load about the pitch axis.

In one embodiment transmitting the force comprises transmitting the force through at least one articulated joint which enables rotation in a yaw axis of the trailer relative to the vehicle.

### BRIEF DESCRIPTION OF DRAWINGS

Notwithstanding any other forms which may fall within the scope of the System and Method as set forth in the Summary, specific embodiments will now be described, by way of example only, with reference to becoming drawings in which:

FIG. 1 is a schematic representation of a vehicle and hitched trailer in relation to which embodiments of the disclosed system and method may be incorporated;

FIG. 2 is a schematic representation of a first embodiment of the disclosed system for changing the load distribution on the wheels of a vehicle when hitched to a trailer;

FIG. 3 is a schematic representation of a second embodiment of the disclosed system for changing the load distribution on the wheels of a vehicle when hitched to a trailer;

FIG. 4 is a schematic representation of a hydraulic system that can drive a third embodiment of the disclosed system for changing the load distribution on the wheels of a vehicle when hitched to a trailer;

FIG. 5 is a schematic representation of an alternate form of hitch in relation to which embodiments of the disclosed method and system may be used;

FIG. 6 illustrates the application of an embodiment of the disclosed system and used in relation to the hitch depicted in FIG. 5;

FIG. 7 is a section view of the system shown in FIG. 6;

FIG. 8 is a front perspective view of the system shown in FIGS. 6 and 7;

FIG. 9 is a circuit diagram of an embodiment of the disclosed system;

FIG. 10 is a schematic representation of a hitch that is slightly modified from that of FIGS. 5-8 and incorporates a fourth embodiment of the disclosed system;

FIG. 11 is a representation of a hitch similar to that of FIG. 10 but further modified to incorporate fifth embodiment of the disclosed system which incorporates the use of return springs for retracting force generator incorporated in the disclosed system;

FIG. 12 is a representation of a hydraulic circuit that may be used in association with the hitching system shown in FIG. 11; and

FIG. 13 is a schematic representation of a sixth embodiment of the disclosed system for changing the load distribution on the wheels of a vehicle when hitched to a trailer incorporating an electrically powered jack.

### DETAILED DESCRIPTION OF SPECIFIC EMBODIMENTS

Specific embodiments of the disclosed system and method will now be described by way of example only. The terminology used herein is for the purpose of describing particular embodiments only and is not intended to limit the scope of the disclosed system and method.

Unless defined otherwise, all technical and scientific terms used herein have the same meanings as commonly understood by one of ordinary skill in the art to pertaining to system and method. In the drawings, it should be understood that like reference numbers refer to like parts.

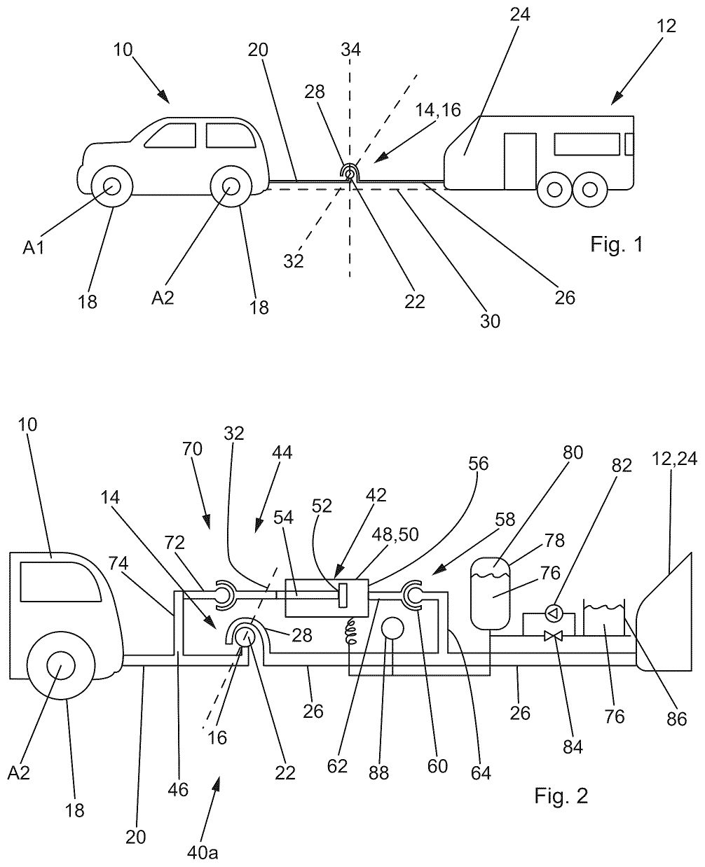

FIG. 1 illustrates a vehicle 10 and a trailer 12 which are coupled together by an overhung tow hitch 14 at a hitch location 16. The vehicle has wheels 18 coupled to axles A1 and A2. The axle A2 is rearward of the axle A1. The vehicle has a towbar 20 which extends rearward of the axle A2 and is fitted with a tow ball 22. The trailer 12 has a main body 24 and a drawbar 26 extending forwards of the main body 26. The drawbar 26 is provided with a receiver 28 that receives the tow ball 22 to couple or hitch the trailer 12 to the vehicle 10. Thus, the hitch 14 comprises the combination of the ball 22 and receiver 28.

As mentioned above the tow hitch 14 allows three degrees of rotational motion, these being:
roll about a roll axis 30, which coincides with a direction forward travel of the vehicle 10;
pitch about a pitch axis 32 which lies in the same horizontal plane as but perpendicular the roll axis 30; and;
yaw about the yaw axis 34 which in this embodiment is a vertical axis.

In this, but not all embodiments, the origin of each of these axes 30, 32 and 34 coincides with the hitch location 16.

When a trailer 12 is coupled to a vehicle 10 by an overhung hitch 14 it may induce a moment about the pitch axis 32. This moment is a result of the downward force due to the weight of the trailer applied via the drawbar 26 on the tow ball 22 and the lever arm comprised of the overhang length of the tow ball 22 beyond the rear axle A2 where this load is resisted. As can be seen this produces a moment in the clockwise direction on the vehicle which results in a reduction in the load on the wheels 18 of axle A1 and an increase in the load on the wheels of axle A2.

With particular reference to FIG. 2 a first embodiment of the system 40a and associated method enable a change in load applied to wheels 18 on different axles A1, A2 and thereby minimise the adverse effect on the dynamics and operation of the vehicle 10 created by the pitch moment applied by the hitched trailer 12.

The system 40a comprises a force generator 42 arranged to apply a force between the vehicle 10 and the trailer 12, and a force transmission coupling 44 arranged to transmit force applied by the force generator 42 for the purpose of changing the load applied to the wheels 18 by the trailer 12. This change in the present embodiment is to counter or oppose the change in load produced by hitching of the trailer to the vehicle.

In the context of this specification, and as highlighted by at least one of the embodiments described herein the expression “force generator” is intended to refer to a device that can bridge two structural components, may be variable in length and exerts a force to the structural components, the magnitude of which can remain at least somewhat constant as length varies. The force generator may be adjustable, such that the force exerted at a given length can be set to different values.

In this embodiment the force generator 42 is in the form of a fluid driven force generator, and more specifically a hydraulic ram 48. The hydraulic ram 48 has a cylinder 50 containing a piston 52. A piston rod 54 extends from one end of the cylinder 50. A blind end 56 of the cylinder 50 is coupled to the drawbar 26 through a structure 58 that includes a rearward articulated joint 60 (hereinafter referred to simply as “joint 60”). The joint 60 provides one or more degrees of freedom of rotational motion. Nonlimiting examples of the joint 60 include a universal joint, and a ball-and-socket joint. The structure 58 includes an arm 62 extending generally parallel to the drawbar 26 and attached between the cylinder 56 and one part of the joint 60, and a right-angle arm 64 attached between another end of the joint 60 and the drawbar 26.

The piston rod 54 is coupled to the tow bar 20 through the force transmission coupling 44. In this embodiment the force transmission coupling 44 is of a similar configuration to the structure 58. More particularly the force transmission coupling 44 includes a forward articulated joint 70 (hereinafter referred to simply as “joint 70”). The joint 70 may be arranged to provide one or more degrees of freedom of rotational motion. Nonlimiting examples of the joint 70 include a universal joint, and a ball-and-socket joint. The force transmission coupling 44 also includes an arm 72 extending generally parallel to the tow bar 20 and attached between the piston rod 54 and one part of the joint 70, and a right-angle arm 74 attached between another part of the joint 70 and the tow bar 20.

Hydraulic fluid 76 is provided under pressure between the blind end 56 of the cylinder 50 and the piston 52. This exerts a force tending to extend the piston rod 54 from the cylinder 50. Accordingly, the force generator 42 applies a force between the vehicle 10 and the trailer 12. By virtue of the force transmission coupling 44 the force on the vehicle 10 is applied at the joint 70 and acts as a moment at the location 46 where the arm 74 connects to the towbar 20. The force exerted by generator 42 is resisted by the ball joint 22/28 (which provides the pitch axis between vehicle and trailer). A moment is caused by the offset between them, the moment being about the pitch axis 32 in a counter clockwise direction on the vehicle. The effect of this moment is to increase the load on the vehicle wheels 18 of the front axle A1 and reduce the load on the wheels 18 on the rear axle A2. This is the opposite to the effect of the moment applied to the vehicle 10 about the pitch axis 32 arising from the load of the hitched trailer 12.

In this, but not every, embodiment the force generator 42 and more particularly the blind side 56 of the cylinder 50 is fluidically coupled to an accumulator 78. The accumulator 78 is a pressure vessel containing a volume of the hydraulic fluid 76 and a volume of a compressed gas 80. The compressed gas 80 may include but is not limited to air or nitrogen. Due to the presence of the compressed gas 80 the accumulator 78 in effect acts as, and indeed can be considered to be, a biased mechanism or spring. The purpose of the accumulator 78 in this embodiment is to keep the moment about the pitch axis approximately constant when a relative pitch angle between vehicle and trailer is induced by road conditions such when driving over uneven terrain, or crest, or spoon drain, or bump etc.

The spring force of the accumulator can be changed by varying the degree of compression of the gas 80. In this embodiment this can be achieved by use of a pump 82 and a valve 84, which are coupled in parallel between the accumulator 78 and a hydraulic fluid tank 86. The pump 82 includes a one-way valve that prevents a reverse flow of fluid when the pump stops. So, when the pump 82 is operated it increases the fluid pressure in the accumulator 78 and thus the force applied by the generator 42. The force of course persists by action of the accumulator 78 when the pump 82 stops. In this way the pump 82 may be considered to act as a driver for the force generator 42 to provide the mechanical force that transfers load between the wheels on different vehicle axles A1 and A2.

Operating the pump 82 pumps hydraulic fluid 76 from the tank 86 to the accumulator 78 and indeed the force generator 42/hydraulic ram 48. Due to the fluid communication between the blind side of the force generator 42 and the accumulator 78, the hydraulic pressure in both is equalised. Assuming there is no or very little displacement of the piston 52, the pumping of the hydraulic fluid 76 increases the compression on the gas 80. This has two related effects, namely increasing the force/moment applied by the force generator 42 to the vehicle 10, and increasing the stiffness (or spring constant) of the accumulator 78.

Conversely this force and spring constant can be reduced by opening the valve 84 allowing hydraulic fluid to drain from the accumulator 78 to the tank 86. A pressure gauge 88 can be used by the operator to provide the desired hydraulic pressure and hence moment on the vehicle 10 applied by the force generator 42 to vary or balance the load on the vehicle wheels 18.

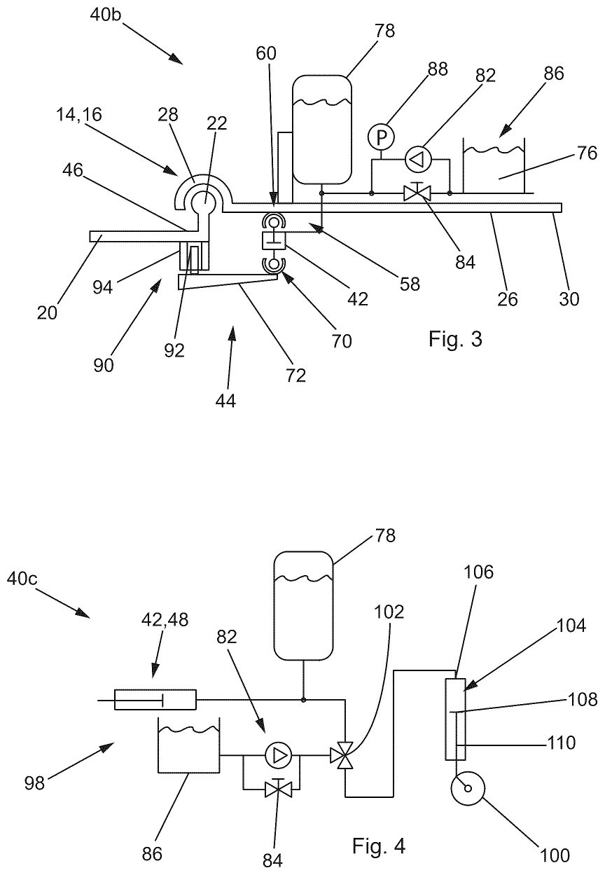

FIG. 3 illustrates a second embodiment of the system 40b, which differs from the first embodiment 40a by way of the:
orientation of the force generator 42;
structure of the force transmission coupling 44;
design of the structure 58; and
location 46 at which the force of the force generator 42 is applied to the vehicle 10.

In the system 40b the force generator 42 while still being in the form of a hydraulic ram is orientated so that its cylinder and piston rod are generally vertically disposed. Also, the force generator 42 is connected to an underside of the drawbar 26. The structure 58 includes a joint 60 providing at least one degree of rotational freedom of movement. The joint 60 may take the same form as in the system 40a. The force transmission coupling 44 comprises an arm 72 and joints 70 and 90 at opposite ends. The arm 72 extends generally parallel to and beneath the drawbar 26 and tow bar 20. The joint 70 connects one end of the arm 72 to the force generator 42 with at least one, and in this embodiment three, degrees of rotational freedom. The joint 90, is an articulated joint and connects the opposite end of the arm 72 to an underside of the towbar 20 with rotational freedom about a yaw (i.e., vertical) axis. In one example the joint 90 may comprise a pin 92 that extends parallel to the yaw axis and is retained within a bearing sleeve 94.

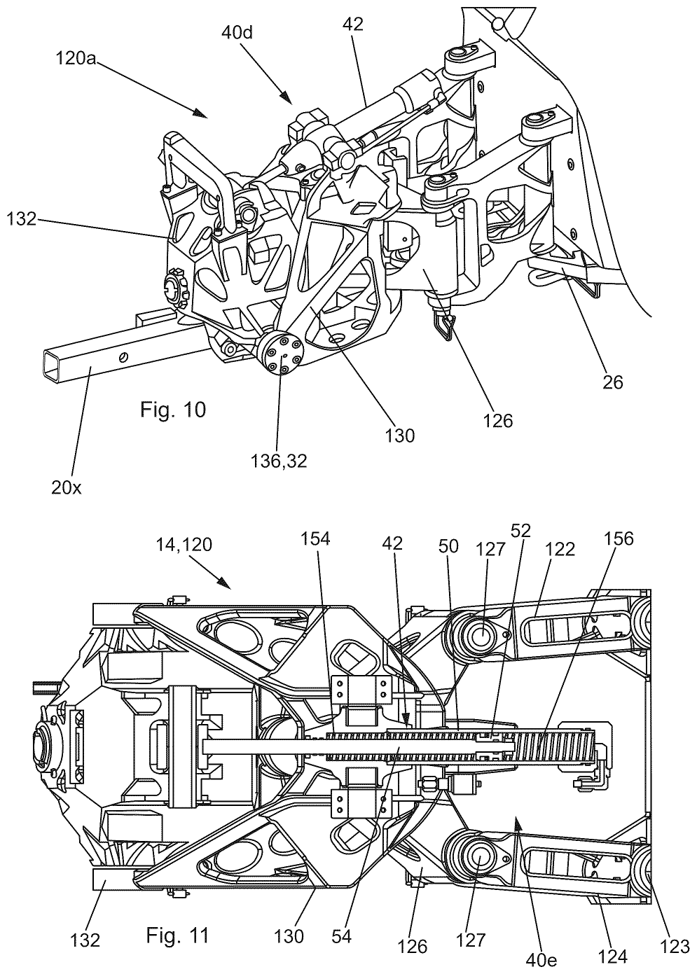

The location 46 at which the force from force generator 42 is applied to the vehicle 10/towbar 20 is much closer to, and indeed may be in the same vertical plane as, the hitch location 16. This exemplifies that the location 46 may lie between: (a) a rearmost of the vehicle axles A2; and, (b) at, or near, the hitch location 16. (The “near” aspect of the location includes being on the trailer side of the hitch location as exemplified in later embodiments shown in FIGS. 10 and 11.) Enabling the arm 72 to pivot about the yaw axis (i.e., axis 34 with reference to FIG. 1) eliminates the need for large motions by the ball joints 60 and 70 on opposite sides of the force generator 42 because the arm 72 follows the trailer drawbar 26 in yaw, i.e., when traversing a corner in the road.

In this embodiment the force applied by the force generator 42 is transmitted through the transmission coupling 44 which generates a moment in a counter-clockwise direction on the vehicle via joint 90 and its towbar 20 in opposition to the moment applied in the clockwise direction by the load of the trailer 12.

The utility of the systems 40a, 40b (hereinafter referred to in general as “system 40”) may be further enhanced by using its hydraulic system 98, which is constituted by the accumulator 78, tank 86, and pump 82, to also operate a jockey wheel 100, as shown in FIG. 4.

The hydraulic system 98 is modified by the inclusion of a three-way valve 102, and a hydraulic ram 104 connected to the jockey wheel 100. The hydraulic ram 104 comprises: a cylinder 106 which is fixed to the trailer 12; an internal piston 108; and a piston rod 110 that extends from the cylinder 106 and is coupled with the jockey wheel 100.

The piston rod 110 can be extended from the cylinder 106 to lower the jockey wheel 100 into contact with the ground by using the three-way valve 102 to switch the output from the pump 82 to the ram 104. The raising of the jockey wheel 100 can be achieved by opening valve 84 and using the weight on the wheel 100 to retract the strut piston rod 110. Alternatively, or additionally a spring 105 (see FIG. 9) may be incorporated in ram 104 which tends to retract the piston 108, allowing the wheel 100 to be retracted off the ground when valve 84 is opened. In a further modification the valve 84 may be spring loaded so that if left unattended it closes automatically, avoiding unwanted jockey wheel 100 retraction (or reduction in force on piston 108).

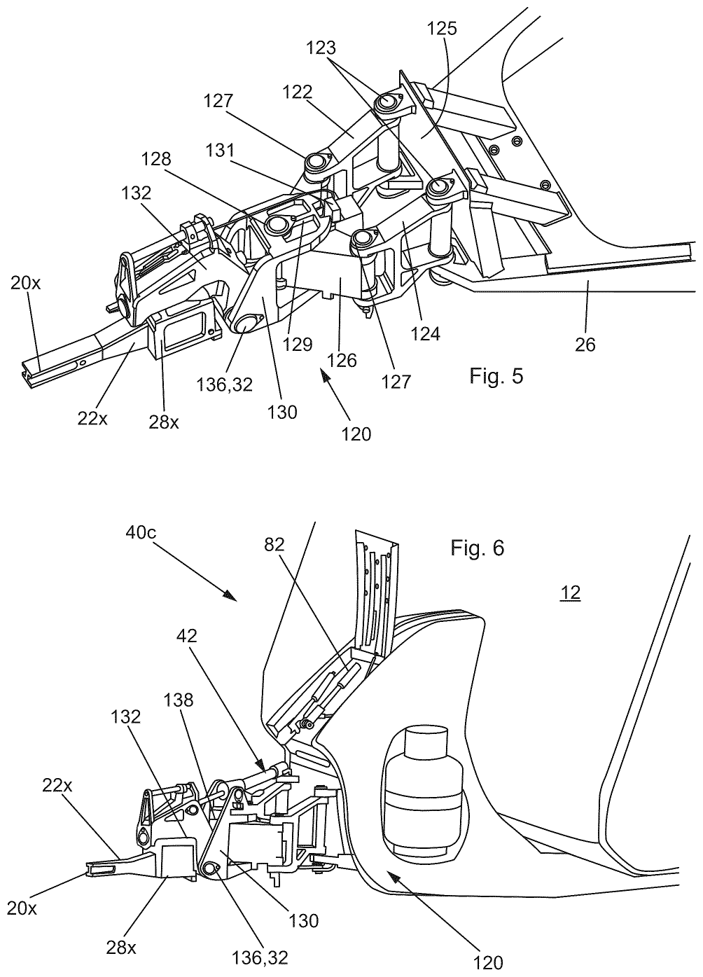

Embodiments of the system 40 depicted in FIGS. 2-4 are shown with reference to a common ball and cup hitch 14. However, embodiments of the system 40 may be applied to or incorporated in other forms of trailer coupling systems, such as one incorporating a four-bar trailer articulated joint 120 as shown in FIGS. 5-8. The articulated joint 120 is of a form and structure as described in Applicant's international application no. PCT/AU2022/050679 (published as WO2023272354), the contents of which are incorporated herein by way of reference. Nevertheless, by way of brief explanation with reference to FIG. 5, the trailer articulated joint 120 comprises frames 122 and 124 each of which is pivotally connected about vertical axes by respective pins 123 to a bracket 125 fixed to the trailer drawbar 26. The opposite end of each frame 122 and 124 is pivotally connected by pins 127 about respective vertical axes to a common block 126. The bracket 125, frames 122, 124 and the block 126 constitute respective “bars” of the four-bar articulated joint 120.

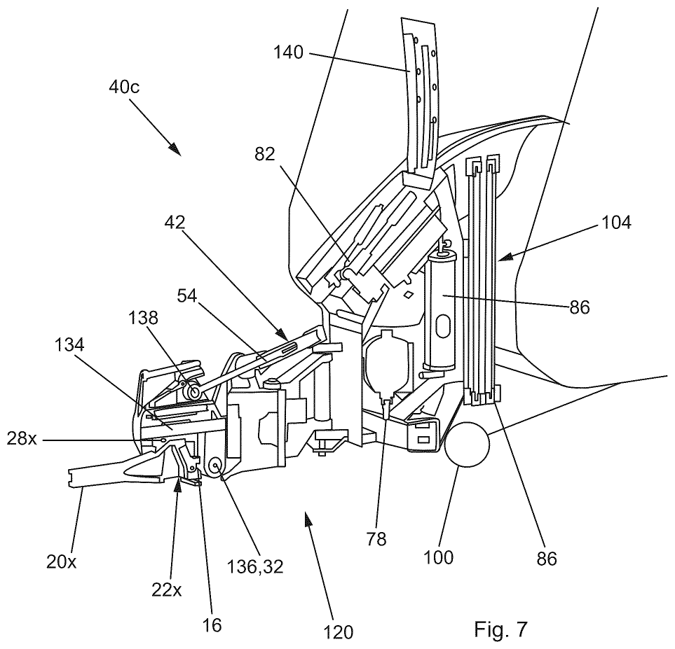

The block 126 is connected by a vertical pin 128 to a housing 130. The housing 130 has a recess 129 into which a latch 131 can be: moved into to lock rotation about the pin 128, and thereby assist in hitching; or, retracted from (as shown in FIG. 5) to allow rotation about the pin 128. The pin 128 allows the block 126 to pivot in yaw relative to a trailer coupler 28x. The trailer coupler 28x is connected to a housing 132 via a pin 134 (visible in FIG. 7) which forms a roll pivot. The housing 132 is pivotally connected to the housing 130 by a pitch pivot pin 136 which form the pitch axis 32. A vehicle coupler 22x is attached to a vehicle 10 by a receiver shank 20x that slides into a receiver tube (not shown) on the towbar (also not shown). Although not material to the operation or structure of the disclosed systems 40, the trailer coupler 28X and the vehicle coupler 22x can take the form of the coupler body and the hitch receiver respectively, as described in Applicant's co-pending application no AU2022903975 the contents of which is incorporated herein by way of reference, for a Hitch Coupling System. Moreover, the trailer coupler 28x and the vehicle coupler 22x may be selectively engaged and disengaged as described in Applicant's co-pending application no PCT/AU2022/050679 mentioned above.

Referring now to FIGS. 6-8, in the embodiment of the system 40c applied to the articulated joint 120, the force generator 42 is connected between the housings 130 and 132. The connection at the housing 132 is by a pivot coupling 138 and arranged so that when the force generator 42 is operated it exerts a moment about the pitch pivot pin 136 thereby changing the weight distribution between the wheels 18 on the front and rear axles A1 and A2. More particularly when the force generator 42 is operated to extend to apply an anti-clockwise moment about the pitch pivot pin 136 it tends to lift a rear end of the vehicle 10 transferring weight/load from the wheels on the rear axle A2 to the wheels on the front axle A1. The pump 82 in the system 40c is in the form of a hand operated pump.

A difference with this embodiment in comparison to that shown in FIGS. 1-3 is that the pitch moment is transferred on the trailer side of the hitch location 16 (see FIG. 7) being the connection point between the vehicle and the trailer. This difference arises due to the structure and design of the 4-bar articulated joint 120. A further difference is that the force generator 42 is integrated into the articulated joint 120. As a result, the articulated joint 120, in combination with the vehicle coupling 22x acts as both the hitch coupling 14 and the force transmission coupling 44 of FIGS. 2 and 3.

FIG. 7 shows a section view of the embodiment of the system 40c and illustrates the relative location and juxtaposition of the accumulator/spring 78, hydraulic reservoir 86, jockey wheel 100 and the jockey wheel hydraulic ram 104.

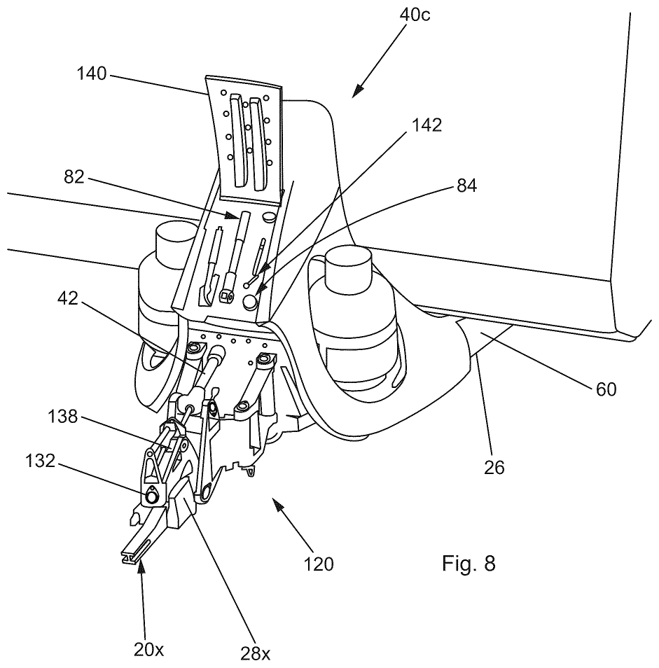

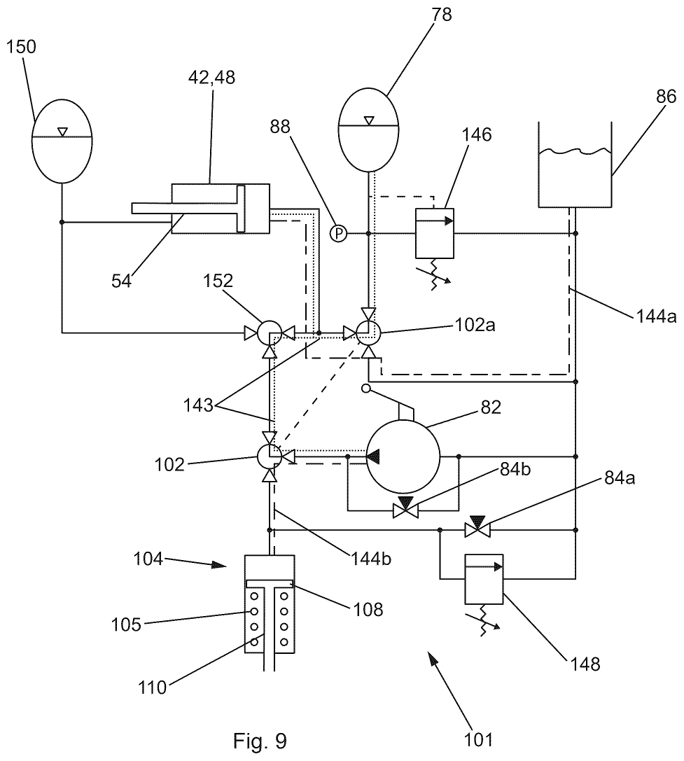

FIG. 8 shows a perspective view of the system 40c with a cover 140 of a control box open exposing the hand operated pump 82, the valve 84, and a lever 142 which is used to operate a valve pair 102a and 102b (explained in more detail below and shown in FIG. 9) which are used to switch the pump 82 between providing fluid to the force generator 42, and the jockey wheel hydraulic ram 104. As will become apparent in the following description the valve pair 102a, 102b are functionally equivalent to the three-way valve 102 shown in and described in relation to FIG. 4.

FIG. 9 shows the hydraulic circuit 101 that can be used in the embodiment of the system 40c shown in FIGS. 5-8. The valves 102a and 102b, (which together from a valve system) are mechanically connected to operate together. In the position shown in FIG. 9 the pump 82 is connected to the accumulator (spring) 78 and force generator 42, as shown by dashed line 143. This is the load levelling configuration of the valves. When valves 102a and 102b are switched together, the pump 82 is connected to the jockey wheel ram 104 (as shown by line 144b), and the force generator 42 is connected to reservoir 86, whilst isolating accumulator 78 (as shown by line 144a). The above-mentioned switching involves a counter clockwise rotation of valve 102a and a clockwise rotation at valve 102b. The valves 102a and 102b are configured such that there is a “dead zone” ensuring that accumulator 78 is not momentarily connected to jockey wheel ram 104. Also, the design of valve 102a ensures that the accumulator 78 is not momentarily connected to the reservoir 86. This ensures that the accumulator 78 stays charged, avoiding the need for excessive operation of the pump 82 achieve the desired force at force generator 42 the next time that load levelling is selected.

A pressure relief valve 146 ensures that any excessive pressure that is generated either by pump 82 or by a reaction force on the force generator 42 is vented to reservoir 86. Similarly, excessive pressure at the jockey wheel ram 104 is vented to the reservoir 86 by a pressure relief valve 148.

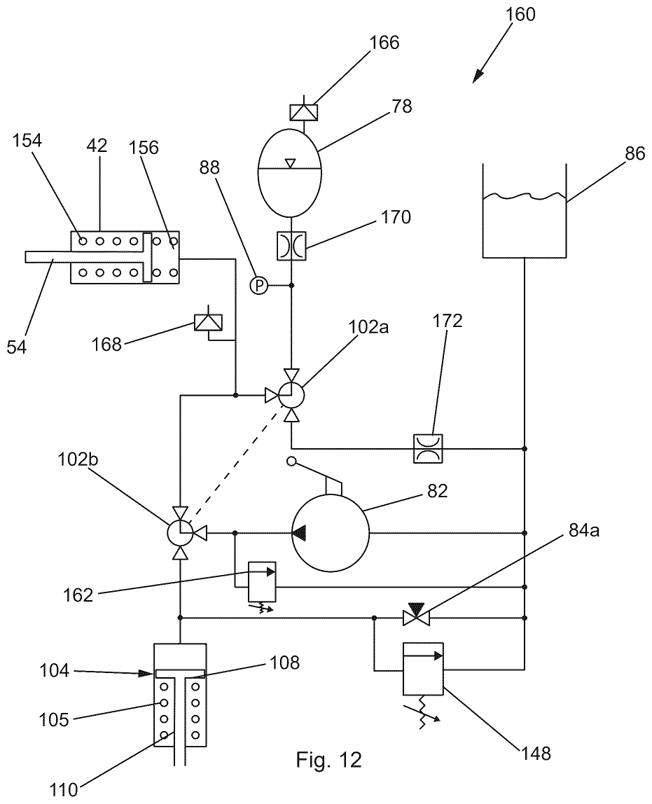

In the above described embodiments, it is assumed that the pump 82 does not allow reverse flow. This can be achieved by using an appropriate positive displacement pump or by the incorporation of a check valve that allows flow in one direction only. In this embodiment a valve 84b is used for retracting the jockey wheel 100 only. Reducing pressure in the accumulator 78 (and hence force at force generator 42) is achieved by opening a valve 84b. Using the two valves (84a and 84b) allows the jockey wheel 100 to be retracted regardless of the position of valves 102a and 102b. But in a variation to this the valves 102a and 102b may be cycled to achieve the same effect, thus doing away with the need for the valve 84b (as indeed shown in the circuit 160 of FIG. 12 described later in this specification). At each cycling of the valves the force generator 42 will extend and contract. On extension, oil is drawn from the accumulator 78, on each contraction a spring (not shown in Figure) in force generator (42) will tend to centre the force generator, thereby discharging oil through the valve 102 a to reservoir 86. The pressure gauge 88 is in fluid communication with the accumulator 78 and can be used by the operator to determine when the desired force at force generator 42 is present.

FIG. 9 also shows the plumbing of an optional second accumulator 150 that may be used to operate the force generator 42 to apply a reverse force to that used to provide load levelling.

This reverse force prevents the hitch coupler 28x (see FIGS. 6 and 8) from falling towards the ground (due to its weight and the weight of housing 132 and the pivot 136 being positioned rearwards of this weight) when the trailer 12 is not hitched to a vehicle 10 and load levelling is not applied (i.e., valve 102a is connecting the force generator 42 to reservoir 86). This makes hitching the trailer 12 to the vehicle 10 easier as it provides clearance for hitch receiver 22x to pass under the hitch coupler 28x when reversing the vehicle 10, thus allowing the two to be readily coupled. The pressure in accumulator 150 can be adjusted by switching a valve 152 to connect the accumulator 150 to the pump 82 with the valve 102b in the load levelling position. The pressure can then be raised by operating the pump 82 or released by opening valve 84b. In normal operation valve 152 would not be operated, the pressure in accumulator 150 can be expected to stay constant for long intervals, only occasional adjustment of pressure in the accumulator 150 should be required.

As indicated earlier in this specification, not every embodiment of the system 40 requires a spring/accumulator 150. The need for a spring/accumulator 150 can be obviated when the system 40 is applied to a coupler that is balanced. The term “balanced” refers to the centre of gravity of the housing 132 (and components within such as the trailer coupler 28x) at or near the pitch axis 32 in the fore/aft direction such that the user, when trying to manipulate housing 132 to the correct orientation to connect the trailer 12 to the vehicle 10, does not need to lift a significant portion of the weight of housing 132 (and components within). An example of this is shown in FIG. 10 in which an embodiment of the system 40d incorporated in an articulated joint 120a is used to couple a trailer to a vehicle. The articulated joint 120a is very similar to the articulated joint 120 shown in FIGS. 5-8 with the exception that the pitch pivot axis 32, and pin 136 are moved forwards so that the articulated joint 120a is now balanced. Thus, the articulated joint 120a utilises an embodiment of the system 40d which omits the accumulator 150 from the hydraulic circuit 101 of the system 40c.

FIGS. 11 and 12 show a further embodiment of the system 40e and an associated hydraulic circuit 160 respectively. The system 40e differs from the system 40d by the inclusion of return springs 154 and 156 within the cylinder 50 of the force generator 42. The return spring 154 surrounds the piston rod 54, and the return spring 156 acts between the blind side of the cylinder 50 and the piston 52. Together the return springs act to return the force generator 42 to a neutral position which is approximately 5° back from the vertical. In this way the springs 154 and 156 act as centering springs.

In the hydraulic circuit 160 the same reference numbers are used to denote the same features as for the hydraulic circuit 101 of FIG. 9. The main, but not only, difference between the hydraulic circuits 101 and 160 is the omission, in the circuit 160, of the accumulator 150 and the associated valve 152 of the circuit 101. The functionality of the accumulator 150 relating to the retraction of the piston 52 is now provided in in the system 40e, by the springs 154 and 156.

In the hydraulic circuit 160 the slaved ball valves 102a, 102b operate to divert hydraulic fluid and pressure from the hand pump 82 to the force generator 42 or the jockey wheel ram 104. The valve 84a in the circuit 160 is a user operated valve that releases pressure from the jockey wheel, allowing it to retract by action of the spring 105.

An over pressure relief valve 162 is in fluid communication between the force generator 42 and the tank 86. The valve 162 provides over pressure relief for the—force generator 42. Possible overpressure scenarios include the force generator 42 being retracted during a change in pitch angle, or the hand pump 82 being operated past its rated pressure.

The circuit 160 also includes:
a burst disc 166 to provide failsafe protection to the accumulator 78, by venting the operating gas (typically nitrogen) to atmosphere if overpressure is reached;
a burst disc 168 to provide failsafe protection of the force generator 42 by venting oil to the atmosphere if a maximum pressure rating for the force generator 42 is exceeded;
a damping orifice 170 which damps fluid returning to the reservoir 86 from the force generator 42, to reduce how quickly the overall system reacts when load levelling is removed; and
a damping orifice 172 that damps fluid flow to and from the accumulator 78, the purpose of which is to reduce how quickly the system reacts when load levelling is applied, and also while driving.

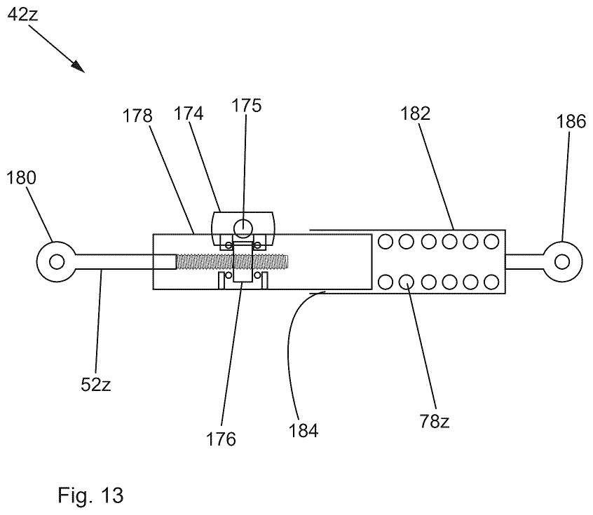

While several exemplary embodiments have been presented in the foregoing detailed description, it should be appreciated that a vast number of variations exist. For example, the force generator 42 is described as a hydraulic cylinder/ram. However, in alternate embodiments the force generator 42 can take different forms including a pneumatic ram, a hydro pneumatic ram, or a screw jack which may be driven either manually, electrically, or by a fluid (i.e., hydraulic or pneumatic) motor. Thus, in broad terms the force generator 42 can be considered to be a fluid or electrically operated force generator. The fluid operated force generators may be pressurised manually (for example by a manual pump) or by a driven motor, such as an electric motor. If a screw jack is used it would be preferable to also incorporate a series connect spring, such as a mechanical spring or a gas strut. FIG. 13 shows an example of an electrically operated force generator 42z in the form of a screw jack. The force generator 42z may be used in place of the force generator 42 shown in the embodiments of FIGS. 2-4, 6-8, 10 and 11. The force generator 42z comprises an electric motor 174 fitted with a worm gear 175, which when powered rotates a nut/pinion 176 held at a fixed location within a tubular body 178. A lead screw 52z threadingly engages the nut 176 and has an eye 180 at a free end located outside of the tubular body 178. The tubular body 178 has one end slidably retained within an outer body 182. An anti-rotation interface 184 acts between the bodies 178 and 182 to allow relative translation but not rotation. In one example the interface 184 can comprise an arrangement of interleaving splines formed on the outer circumferential surface of the body 178 and the inner circumferential surface of the body 182. A preloaded mechanical spring 78z is held within the body 182 biasing the body 178 outwardly. An end of the body 182 distant the body 178 is provided with an eye 186 to facilitate mechanical coupling to an embodiment of the previously described systems 40.

Operating the motor 174 to rotate in one direction causes the nut 176 to rotate and extend the lead screw 52z further out of the body 178. This is the same effect in terms of load balancing as extending the piston rod 52 of the hydraulic force generators 42 described in the previous embodiments. Similarly, the action of the spring 78z is equivalent to the accumulator 78 described in the previous embodiments.

To avoid the need to continuously provide power to the motor 174 after load balancing has been achieved, a locking arrangement may also incorporated into the force generator 42z. In one embodiment the locking arrangement may be provided by designing the lead screw 52z and/or the worm 175 so that they do not back drive and so do not rotate when a load is present between eyes 180 and 186. In an alternate embodiment, motor 174 may be fitted with a brake that locks the motor to prevent back driving when power is not applied. The brake is spring loaded so that it applies when deenergized and releases when it and the motor 174 are energised. In a less sophisticated embodiment the locking arrangement may be provided as one or two locking nuts threaded on a portion of the lead screw 52z outside of the body 178. The lock nut(s) can be manually rotated to about the outside of the body 178 when the load levelling process has been completed.

Depending on the type of motor 174, retraction of the lead screw 52z (after release of any locking arrangement) can be achieved by either (a) essentially doing nothing allowing the motor and thus the nut to freewheel by action of the moments and counter moments applied by the vehicle and trailer; or (b) operating the motor 174 to rotate in an opposite direction, e.g., for a DC motor reversing the polarity of connection to a power source. Alternately in a more sophisticated variation a gear box may be provided between the electric motor 174 and the nut 176 to allow selection of the rotation direction of the nut 176 and thus the extensional retraction of the lead screw 52z.

Embodiments of the system 40 which include the electrically operated screw jack 42z, may also be provided with an additional electrically operated screw jack to extend and retract the jockey wheel 100. This would replace the hydraulic ram 104 shown in previous embodiments.

It should also be appreciated that the exemplary embodiments of the system and method are only examples, and are not intended to limit the scope, applicability, or configuration of the present disclosure in any way. Rather, the foregoing detailed description will provide those skilled in the art with a convenient road map for implementing an exemplary embodiment of the disclosed system and method.

In the claims which follow, and in the preceding description, except where the context requires otherwise due to express language or necessary implication, the word “comprise” and variations such as “comprises” or “comprising” are used in an inclusive sense, i.e., to specify the presence of the stated features but not to preclude the presence or addition of further features in various embodiments of the system and method as disclosed herein.

1. A system for enabling a change in load applied to wheels on different axles of a vehicle about a pitch axis of the vehicle by a trailer when coupled to the vehicle by a hitch coupling, the system comprising:
a fluid or electrically operated adjustable force generator of variable length arranged to apply a force between the vehicle and the trailer, and
a force transmission coupling arranged to transmit the force applied by the force generator to the vehicle to change the load applied to the wheels by the trailer about the pitch axis, wherein the force is applied to produce a moment about the pitch axis in a direction opposite to a moment produced by a coupled trailer about the pitch axis when coupled to the vehicle, and wherein the force is substantially constant over a range of motion of the force generator.

2. The system according to claim 1 wherein the trailer is coupled to the vehicle at an overhung hitch location.

3. The system according to claim 1 comprising a forward articulated joint coupled between the vehicle and the force generator, wherein the forward articulated joint provides at least one degree of freedom of rotational motion.

4. The system according to claim 3 wherein the at least one degree of freedom of rotational motion is rotational motion about a yaw axis of the vehicle.

5. The system according to claim 1 comprising a rearward articulated joint coupled between the force generator and the trailer, wherein the rearward articulated joint provides at least one degree of freedom of rotational motion.

6. The system according to claim 1 wherein the force transmission coupling is arranged to transmit the force as a moment in a direction about the pitch axis that acts to reduce the load applied to the wheels by the trailer.

7. The system according to claim 1 comprising a driver arranged to drive or operate the force generator for producing the mechanical force.

8. The system according to claim 7 comprising a jockey wheel extension and retraction mechanism operatively associated with the driver.

9. The system according to claim 8 wherein the driver is a pump, and the system includes an accumulator and a valve system, wherein the pump is in selective fluid communication with the force generator, the accumulator, and the jockey wheel extension and retraction mechanism through the valve system, the valve system being operable to move though an intermediate dead zone between (a) a load levelling configuration where the valve system fluidically connects the pump to the force generator and the accumulator fluid communication; and (b) a second configuration where the valve system fluidically connect the pump to the jockey wheel extension and retraction mechanism; and wherein during the dead zone the valve system prevents fluidic connection between the accumulator and the jockey wheel extension and retraction mechanism.

10. The system according to claim 1 wherein the force generator includes a fluid driven force generator.

11. The system according to claim 9 wherein the fluid driven force generator is a hydraulic cylinder or a pneumatic cylinder, or a hydropneumatic cylinder.

12. The system according to claim 10 wherein the fluid driven force generator is a hydraulic cylinder, and the driver comprises a pump for supply fluid pressure to the hydraulic cylinder.

13. The system according to claim 11 comprising an accumulator in fluid communication with the fluid driven force generator and the pump.

14. The system according to claim 1 wherein the force generator includes a manually driven jack, an electrically driven jack, or a fluid driven jack.

15. The system according to claim 14 wherein a spring is mounted in series with the jack to provide substantially constant force over a range of motion of the jack.

16. A method of enabling a change in load applied to wheels on different axles of a vehicle about a pitch axis of the vehicle by a trailer when coupled to the vehicle by a hitch coupling, the method comprising:
applying an adjustable force between the vehicle and the trailer using a force generator of variable length,
transmitting the force to the vehicle at a location rearward of the vehicle axles as a moment about the pitch axis in a direction opposite to a moment produced by the trailer about the pitch axis and wherein the force is substantially constant over a range of motion of the force generator.

17. The method according to claim 16 wherein transmitting the force comprises transmitting the force as a moment about the pitch axis in a direction opposite to a moment produced by the trailer about the pitch axis.

18. The method according to claim 17 wherein transmitting the force comprises transmitting the force through at least one articulated joint which enables rotation in a yaw axis of the trailer relative to the vehicle.
